(19) United States
(12) Patent Application Publication
(10) Pub. No.: US 2002/0068607 A1
(43) Pub. Date: Jun. 6, 2002

(54) Wireless telephonically accessed computer services and system

(76) Inventors: Randice-Lisa Altschul, Cliffside Park, NJ (US); Lee S. Volpe, Mount Laurel, NJ (US)

Correspondence Address: Arthur Jacob, 25 East Salem Street, P.O. Box 686, Hackensack, NJ, 07602, US

(21) Appl. No.: 09/728,019

(22) Filed: Dec. 1, 2000

(51) Int. Cl. H04B 1/38

(52) U.S. Cl. 455/557; 455/556; 455/411

(57) ABSTRACT

A wireless telephonically accessed computer service and system includes a highly compact terminal having a user transceiver which communicates telephonically with a provider transceiver for accessing a full range of computer services performed by a computer system maintained by a provider at a provider site while the terminal is placed at a user location remote from the provider site.

The present invention relates generally to computerized information and data services and pertains, more specifically, to a system and method for the storage, retrieval and processing of computerized information and data at a provider site in response to the operation of a remote, highly compact wireless telephonic terminal.

The rapid development of the personal computer over recent years has revolutionized the delivery and processing of information and data. With that development, personal computers and systems which operate these computers have become more complex and often more difficult to operate in home and office settings where computers are used by ordinary users not trained extensively in the technical details of computer construction and operation. Attempts at simplifying the operation of computers have encouraged increased numbers of users to enter the so-called computer age; however, entry into the present computer age often requires a considerable investment in equipment and training time for the effective use of current computer systems.

The present invention eliminates the need for investing in complex and expensive equipment in order to take advantage of the most up-to-date information delivery and data processing facilities available to computer users, while simplifying the entire access and processing operations so as to provide ready access to the most powerful available information and processing facilities by even the least sophisticated users. As such, the present invention attains several objects and advantages, some of which are summarized as follows: Provides a highly effective, relatively inexpensive computer system made available for ready use by a wider range of users; eliminates the necessity for investing in relatively expensive computer hardware and software in order to enable the use of the most up-to-date and effective information delivery and data processing systems available; provides a highly compact, mobile and versatile remote terminal for accessing and using even the most sophisticated information delivery and data processing computer systems available; provides powerful computing ability at relatively low cost and increased ease of use; reduces the complexity of information and data management for more economical computer-based operations; provides more effective protection of specific information and data records against loss or theft, while maintaining ease of access as required; places the latest advances in computer information delivery and data processing in the hands of a wider audience for better education, communication and commerce among a greater number of people.

The above objects and advantages, as well as further objects and advantages, are attained by the present invention which may be described briefly as a wireless telephonically accessed computer services system for enabling a computer service provider at a provider site to provide a full range of computer services to a user placed at a location remote from the provider site, the system comprising: a highly compact terminal having: a terminal body having compact dimensions, including a limited length, a limited width and a limited thickness; a data input device; a monitor; and a wireless telephonic user transceiver for transmitting data in response to the data input device, and for receiving data for review at the monitor; a provider transceiver at the provider site; and a provider computer system responsive to the provider transceiver for processing data transmitted from the user transceiver to the provider transceiver, the provider transceiver being responsive to the provider computer system for transmitting processed data from the provider computer system to the user transceiver.

In addition, the present invention provides a highly compact terminal for use in a wireless telephonically accessed computer services system for enabling a computer service provider at a provider site to provide a full range of computer services to a user placed at a location remote from the provider site, the terminal comprising: a terminal body having compact dimensions, including a limited length, a limited width and a limited thickness; a data input device; a monitor; and a w i r e l e s s telephonic user transceiver for transmitting data to the computer services system in response to the data input device, and for receiving data from the computer services system for review at the monitor.

Further, the present invention includes a method for providing wireless telephonically accessed computer services so as to enable a computer service provider at a provider site to provide a full range of computer services to a user placed at a location remote from the provider site, the method comprising: providing a highly compact terminal having: a terminal body with compact dimensions, including a limited length, a limited width and a limited thickness; a data input device; a monitor; and a w i r e l e s s telephonic user transceiver for transmitting data in response to the data input device, and for receiving data for review at the monitor; transmitting selected data from the user transceiver to a provider transceiver at the provider site; processing data transmitted from the user transceiver to the provider transceiver in a provider computer system at the provider site; and transmitting data processed in the provider computer system at the provider site to the user transceiver for review at the monitor.

The invention will be understood more fully, while still further objects and advantages will become apparent, in the following detailed description of preferred embodiments of the invention illustrated in the accompanying drawing, in which:

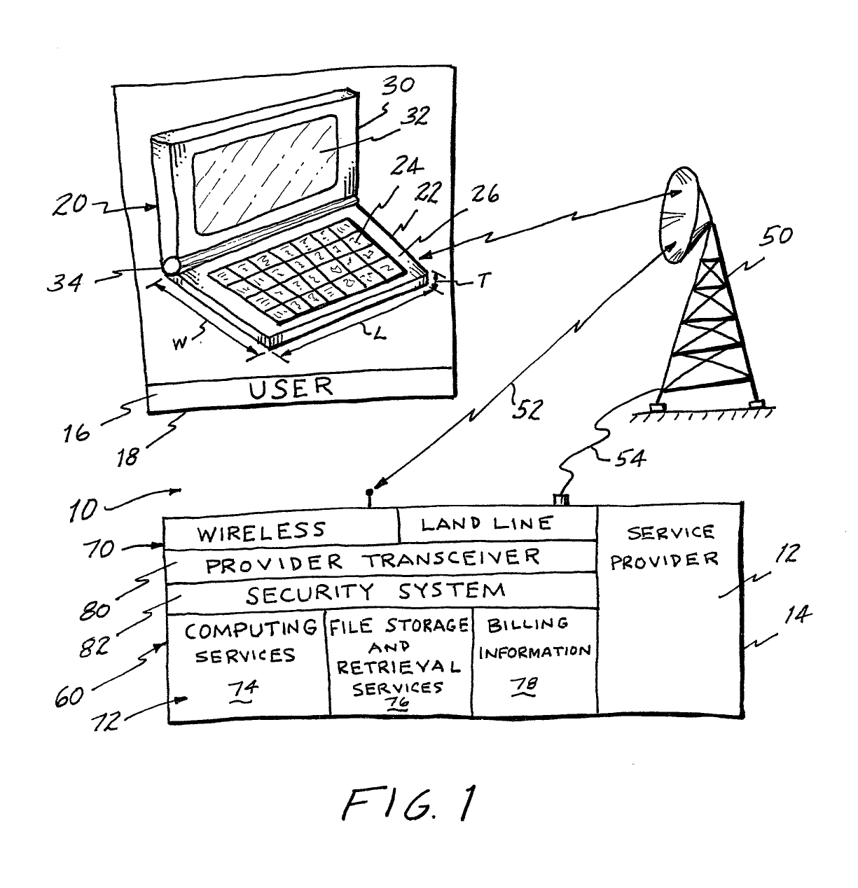

FIG. 1 is a diagrammatic illustration of a system constructed in accordance with the present invention for providing computer services in accordance with the invention;

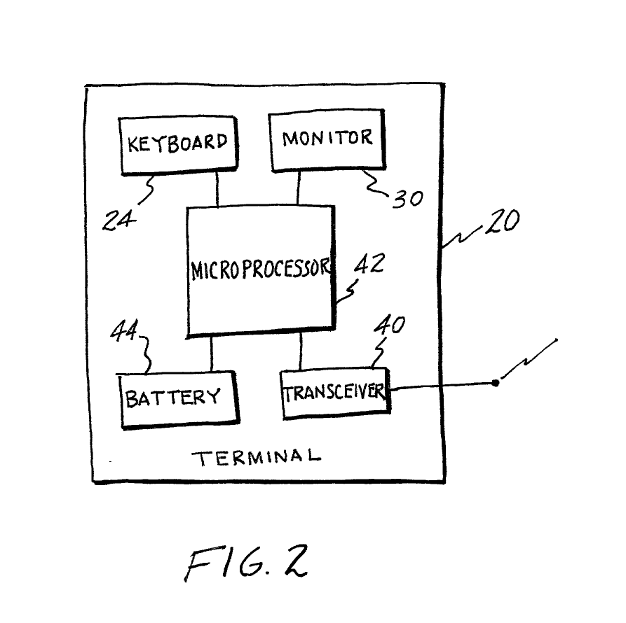

FIG. 2 is a schematic diagram showing the operating circuitry of a terminal constructed in accordance with the present invention; and

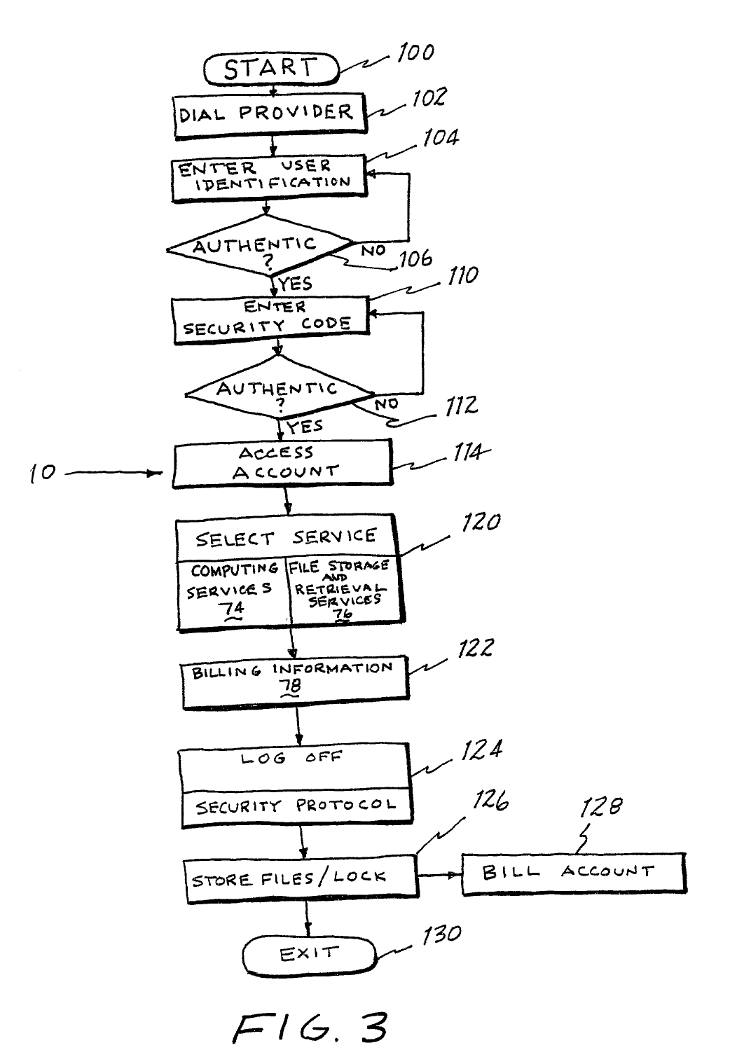

FIG. 3 is a flow chart demonstrating the operation of the system of the present invention.

Referring now to the drawing, and especially to FIG. 1 thereof, a computer services system constructed in accordance with the present invention is shown in the form of a wireless telephonically accessed computer services system 10 and is seen to enable a computer service provider 12, located at a provider site 14, to provide a full range of computer services to a user 16 is placed at a location 18 remote from the provider site 14. System 10 includes a terminal 20 which is fully mobile and readily carried by the user 16 to almost any remote location 18.

Terminal 20 is highly compact and includes a terminal body 22 having compact dimensions, including a limited length L, a limited width W and a limited thickness T. Typically, length L is about eight inches, width W is about six inches, and thickness T is a fraction of an inch, similar to the thickness of a conventional credit card, all of which dimensions are attained by a construction technique fully described in U.S. Pat. No. 5,965,848, granted to Altschul et al., the subject matter of which is incorporated herein by reference thereto. A data input device is shown in the form of a keyboard 24 integrated into the terminal body 22 at obverse face 26 of the body 22, in a manner fully described in the aforesaid patent. A monitor 30 includes a visual display, preferably in the form of an LCD display 32, juxtaposed with the keyboard 24 for displaying data in accordance with the commands entered at the keyboard 24. In the preferred construction, the monitor 30 is hinged to the body 22 at 34 for selected movement between the erect, open position illustrated in FIG. 1, wherein the terminal 20 is ready for use, and a folded, closed position wherein the monitor 30 overlies the obverse face 26 of the body 22 and covers the keyboard 24 in a closed-book-like configuration for convenient carrying and storage of the terminal 20.

As seen in FIG. 2, terminal 20 includes a wireless telephonic user transceiver, shown in the form of transceiver 40, which is operated by a microprocessor 42, for transmitting data in response to operation of the keyboard 24. A battery 44, preferably located in the body 22 of the terminal 20, supplies power for the operation of the terminal 20.

Returning now to FIG. 1, data entered by the user 16 at the keyboard 24 is transmitted, by transceiver 40 in a wireless transmission, to a relay tower 50 which, in turn, transmits the data to the provider site 14, either by wireless transmission, indicated at 52, or by land line transmission, indicated at 54. The service provider 12 maintains a full service computer system 60 at the provider site 14 and makes the computer system 60 available to user 16 through a subscription agreement between the user 16 and the service provider 12. An account 70 provides the user 16 with a user-specific account arrangement 72 which includes computing services 74 and file storage and retrieval services 76, as well as billing information 78. A provider transceiver 80 enables telephonic access to account arrangement 72, and a security system 82 is interposed between provider transceiver 80 and account arrangement 72 for precluding unauthorized access to account arrangement 72 by requiring an access code for authorized access to account arrangement 72.

Turning now to FIG. 3, a subscribing user 16 starts the operation of the system 10 at step 100 by opening the terminal 20 to gain access to the keyboard 24 and to turn on the terminal 20. The user 16 then uses the keyboard 24 to dial the provider 12, at step 102, and enters a user identification, at step 104. The user identification may be as simple as a personal identification number (PIN), or as complex as a biometric identifier, such as that obtained from a fingerprint reader or a retinal reader. The identification is authenticated at step 106. If the identification is not authentic, the operation returns to step 104 for the entry of an authentic identification. If no authentic identification is entered after a predetermined number of entries, the operation will be terminated. If the identification is authenticated, access is gained to the security system 82 and a security code is entered, at step 110. If the security code is not authenticated, at step 112, the operation returns to step 110 for entry of an authentic security code. If an authentic security code is not entered after a predetermined number of entries, the operation will be terminated. If the security code is authenticated, access is gained to the user-specific account arrangement 72, at step 114.

Once the user 16 has gained access to the account 72, all of the computer system services offered by the provider 12 are made available to the user 16, through terminal 20. Data entered at keyboard 24 is transmitted by user transceiver 40 for reception by provider transceiver 80 and subsequent processing by service computer system 60. Processed data is transmitted by provider transceiver 80, in response to service computer system 60, to user transceiver 40 for review by viewing at display 32 of monitor 30. The user 16 can select, at step 120, any of the computing services 74 available in the computer services system 10 such as, for example, programs for word processing, for business and accounting management, for financial management, for graphic applications, for games, for entertainment, for education, as well as for other categories made available for computer processing. Additional services, such as Internet access and other on-line services may be provided to the user 16 by the service provider 12, through computing services 74, as well as additional information services. The user 16 may select file storage and retrieval services 76 to access the user's stored files or to store new files. User billing information is predicated upon the use of the offered services and is transmitted to billing information 78, at step 122.

Upon completion of a session, user 16 logs off, at step 124, all files are stored and locked, at step 126, following a security protocol portion of log-off step 124, and the user account 70 is billed, at step 128. The security protocol assures that the user's files are secure against access, including against access by the service provider 12. The user 16 then exits the system 10, at step 130.

A full range of computer services is made available to the user 16 through the simplified, compact terminal 20. All of the computing capacity necessary to provide such a full range of services is located at the provider site 14, and need not be placed at the remote user location 18 of the user 16. All of the latest, most advanced computing equipment, services, accessories and peripherals are available to the user 16 essentially instantly with simple upgrades performed by the provider 12 at the provider site 14. The user 16 need not invest in expensive elaborate hardware in order to have immediate access to the most up-to-date computer system available. Moreover, the user's files are stored safely and securely at the provider site 14, are available to the user 16 at virtually any user location 18, and are not subject to damage, loss or theft which otherwise could occur if these records were maintained at the user location 18. The terminal 20 itself is relatively inexpensive and is replaced readily, if replacement should become necessary through breakage, loss or theft. Terminal 20 is compact, easily carried during travel and readily placed into use. Since computing hardware and software is confined to the provider site 14, computer services system 10 is essentially immune to computer viruses. The thin, lightweight construction of terminal 20, fabricated as described in the aforementioned patent, is tamper-resistant, shock-resistant and water-resistant, enabling maximum portability with rugged reliability. Further, terminal 20 is so inexpensive in construction as to enable terminal 20 to be expendable and made disposable, as described in connection with U.S. Pat. No. 5,875,393 granted to Altschul et al., the subject matter of which patent is incorporated herein by reference thereto.

It will be seen that the present invention attains the several objects and advantages summarized above, namely: Provides a highly effective, relatively inexpensive computer system made available for ready use by a wider range of users; eliminates the necessity for investing in relatively expensive computer hardware and software in order to enable the use of the most up-to-date and effective information delivery and data processing systems available; provides a highly compact, mobile and versatile remote terminal for accessing and using even the most sophisticated information delivery and data processing computer systems available; provides powerful computing ability at relatively low cost and increased ease of use; reduces the complexity of information and data management for more economical computer-based operations; provides more effective protection of specific information and data records against loss or theft, while maintaining ease of access as required; places the latest advances in computer information delivery and data processing in the hands of a wider audience for better education, communication and commerce among a greater number of people.

It is to be understood that the above detailed description of preferred embodiments of the invention is provided by way of example only. Various details of design, construction and procedure may be modified without departing from the true spirit and scope of the invention, as set forth in the appended claims.

The embodiments of the invention in which an exclusive property or privilege is claimed are defined as follows:

1. A wireless telephonically accessed computer services system for enabling a computer service provider at a provider site to provide a full range of computer services to a user placed at a location remote from the provider site, the system comprising:
a highly compact terminal having:
a terminal body having compact dimensions, including a limited length, a limited width and a limited thickness;
a data input device;
a monitor; and
a wireless telephonic user transceiver for transmitting data in response to the data input device, and for receiving data for review at the monitor;
a provider transceiver at the provider site; and
a provider computer system responsive to the provider transceiver for processing data transmitted from the user transceiver to the provider transceiver, the provider transceiver being responsive to the provider computer system for transmitting processed data from the provider computer system to the user transceiver.

2. The invention of claim 1 wherein the provider computer system includes a user account arrangement, and a security system interposed between the user account arrangement and the provider transceiver for precluding unauthorized access to the user account arrangement, the security system being responsive to the provider transceiver for allowing access to the user account arrangement in response to an access code received by the provider transceiver from the user transceiver.

3. The invention of claim 1 wherein the input device includes a keyboard integral with the terminal body.

4. The invention of claim 3 wherein the terminal body has an obverse face and a reverse face, and the keyboard is placed at the obverse face.

5. The invention of claim 3 wherein the monitor includes a visual display integral with the terminal body for enabling visual review at the monitor, the visual display being juxtaposed with the keyboard for enabling viewing of the visual display by the user while the user operates the keyboard.

6. A highly compact terminal for use in a wireless telephonically accessed computer services system for enabling a computer service provider at a provider site to provide a full range of computer services to a user placed at a location remote from the provider site, the terminal comprising:
a terminal body having compact dimensions, including a limited length, a limited width and a limited thickness;
a data input device;
a monitor; and
a wireless telephonic user transceiver for transmitting data to the computer services system in response to the data input device, and for receiving data from the computer services system for review at the monitor.

7. The invention of claim 6 wherein the input device includes a keyboard integral with the terminal body.

8. The invention of claim 7 wherein the terminal body has an obverse face and a reverse face, and the keyboard is placed at the obverse face.

9. The invention of claim 7 wherein the monitor includes a visual display integral with the terminal body for enabling visual review at the monitor, the visual display being juxtaposed with the keyboard for enabling viewing of the visual display by the user while the user operates the keyboard.

10. A method for providing wireless telephonically accessed computer services so as to enable a computer service provider at a provider site to provide a full range of computer services to a user placed at a location remote from the provider site, the method comprising:
providing a highly compact terminal having:
a terminal body with compact dimensions, including a limited length, a limited width and a limited thickness;
a data input device;
a monitor; and
a wireless telephonic user transceiver for transmitting data in response to the data input device, and for receiving data for review at the monitor;
transmitting selected data from the user transceiver to a provider transceiver at the provider site;
processing data transmitted from the user transceiver to the provider transceiver in a provider computer system at the provider site; and
transmitting data processed in the provider computer system at the provider site to the user transceiver for review at the monitor.

11. The invention of claim 10 wherein the provider computer system includes a user account arrangement, and the method includes precluding unauthorized access to the user account arrangement, and allowing authorized access to the user account arrangement in response to an access code received by the provider transceiver from the user transceiver.

12. The invention of claim 10 wherein the input device includes a keyboard, the monitor includes a visual display, and the method includes juxtaposing the visual display with the keyboard for enabling viewing of the visual display by the user while the user operates the keyboard.
